(19) United States
(12) Patent Application Publication
(10) Pub. No.: US 2008/0223849 A1
(43) Pub. Date: Sep. 18, 2008

(54) Ceramic heater and gas sensor element

(75) Inventors: Susumu Naito, Kariya-shi (JP); Atsushi Iwata, Kuwana-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/000,661

(22) Filed: Dec. 14, 2007

(30) Foreign Application Priority Data
Dec. 15, 2006 (JP) 2006-337913

(51) Int. Cl. H05B 3/16; H05B 3/10

(52) U.S. Cl. 219/543; 219/553; 219/548

(57) ABSTRACT

In a ceramic heater according to the invention, a heating section has a meandering shape to include a pair of first straight segments, a plurality of second straight segments, and a plurality of curved segments. Each of the first straight segments extends in the longitudinal direction of a ceramic sheet and has a center line. The second straight segments are interposed between the first straight segments in the lateral direction of the ceramic sheet. Each of the second straight segments extends obliquely with respect to the longitudinal direction of the ceramic sheet. Each of the curved segments connects ends of an adjacent pair of the first and second straight segments and has a center line. The sum of curvature diameters of the center lines of the curved segments is greater than a distance between the center lines of the first straight segments in the lateral direction of the ceramic sheet.

### CROSS-REFERENCE TO RELATED APPLICATION

This application is based on and claims priority from Japanese Patent Application No. 2006-337913, filed on Dec. 15, 2006, the content of which is hereby incorporated by reference in its entirety into this application.

### BACKGROUND OF THE INVENTION

1 Technical Field of the Invention The present invention relates to a ceramic heater that includes a ceramic sheet and a heater pattern formed on the ceramic sheet and a gas sensor element that includes the ceramic heater.

2 Description of the Related Art

A gas sensor element is generally used in an internal combustion engine to detect, for example, the air-fuel ratio of the engine or the concentration of a specific gas component. Further, a ceramic heater is generally used to heat the gas sensor element during a start operation of the engine. The ceramic heater may be made by a method including the steps of: 1) printing a conductive paste of Pt or the like on an insulative ceramic sheet to form a heater patter; 2) firing the ceramic sheet with the heater pattern in an environment of a high temperature, for example, up to 1600° C.

FIG. 4 shows a conventional ceramic heater 9, where a heater pattern 93 includes a heating section 930 for generating heat and a pair of lead sections 940 for supplying electric power to the heating section 930. The heating section 930 has a meandering shape to include a pair of first straight segments 931, a pair of second straight segments 933, a pair of first curved segments 932A, and a second curved segment 932B. The first straight segments 931 are respectively arranged on an opposite pair of laterally outer portions 921 of a ceramic sheet 92 to extend in the longitudinal direction D of the ceramic sheet 92; they are also respectively connected to the lead sections 940. The second straight segments 933 are interposed between the first straight segments 931 in the lateral direction of the ceramic sheet 92 and extend in the longitudinal direction D of the ceramic sheet 92. Each of the first curved segments 932A connects ends of an adjacent pair of one of the first straight segments 931 and one of the second straight segments 933. On the other hand, the second curved segment 932B connects ends of the pair of the second straight segments 933.

A gas sensor element including such a ceramic heater 9 is disclosed, for example, in Japanese Patent Application Publication No. 2000-65782. Moreover, in Japanese Patent Application Publication No. S 59-163558, there is disclosed a ceramic heater that includes a heater pattern having a meandering heating section.

In recent years, it has been required for gas sensor elements to have a prompt activation capability. One effective approach to meeting this requirement is to decrease the thermal capacities of the gas sensor elements by downsizing them. Accordingly, the ceramic heaters used in the gas sensor elements are also required to be downsized.

However, when the width of the above-described ceramic heater 9 is reduced for the purpose of downsizing, the curvature diameters (i.e., quantities twice the curvature radiuses) R1′, R2′, and R3′ of the first and second curved segments 932A and 932B of the heater pattern 93 will be accordingly reduced. Further, with the reduced curvature diameters R1, R2, and R3, it is difficult to secure the quality of printing the heater pattern 93 on the ceramic sheet 92, thus causing defects such as fading of the first and second curved segments 932A and 932B. Consequently, due to the defects, the distribution of electric resistance in the heater pattern 93 will become irregular. As a result, in the heater pattern 93, local heat concentration will occur during operation, causing a break or cracks due to excessive heat stress.

### SUMMARY OF THE INVENTION

The present invention has been made in view of the above-mentioned problems.

It is, therefore, a primary object of the present invention to provide a ceramic heater, which includes a heater pattern having a reduced width and formed with high quality, and a gas sensor element that includes the ceramic heater.

According to a first aspect of the present invention, there is provided a ceramic heater that includes an insulative ceramic sheet and a heater pattern.

The insulative ceramic sheet has first and second ends that are opposite to each other in a longitudinal direction of the ceramic sheet. The heater pattern is formed on the ceramic sheet and includes a heating section for generating heat. The heating section has a meandering shape to include a pair of first straight segments, a plurality of second straight segments, and a plurality of curved segments. Each of the first straight segments extends in the longitudinal direction of the ceramic sheet and has a center line. The second straight segments are interposed between the first straight segments in a lateral direction of the ceramic sheet which is perpendicular to the longitudinal direction of the ceramic sheet. Each of the second straight segments extends obliquely with respect to the longitudinal direction of the ceramic sheet. Each of the curved segments connects an adjacent pair of the first and second straight segments and has a center line. Further, the sum of curvature diameters of the center lines of the curved segments is greater than a distance between the center lines of the first straight segments in the lateral direction of the ceramic sheet.

With the above configuration, it is possible to secure large curvature diameters of the curved segments while reducing the overall width of the heater pattern.

Consequently, with the large curvature diameters, it is possible to ensure that the heater pattern is formed on the ceramic sheet with high quality. Further, with the high quality, the distribution of electric resistance in the heater pattern can be made regular, thereby preventing the occurrence of a break or cracks due to excessive heat stress in the heater pattern. Moreover, with the reduced overall width, the ceramic heater can be downsized. As a result, both the reliability and compactness of the ceramic heater can be secured.

According to a further implementation of the invention, in the ceramic heater, the heater pattern further includes a pair of lead sections for supplying electric power to the heating section. The lead sections are arranged on the ceramic sheet in alignment with each other in the lateral direction of the ceramic sheet and closer to the second end of the ceramic sheet than the heating section in the longitudinal direction of the ceramic sheet. Each of the first straight segments includes first and second ends that are opposite to each other in the longitudinal direction of the ceramic sheet. The second end of each of the first straight segments is connected to a corresponding one of the lead sections. The plurality of second straight segments are only two second straight segments, each of which includes a first end and a second end that is closer to the lead sections than the first end of the second straight segment. The plurality of curved segments consist of a pair of first curved segments and a second curved segment. Each of the first curved segments connects the first ends of an adjacent pair of one of the first straight segments and one of the second straight segments. The second curved segment connects the second ends of the pair of the second curved segments.

With the above configuration, it is possible to make the shape of the heater pattern simple and suitable and the heating performance of the same excellent. Moreover, it is also possible to draw leads for supplying electric power to the heating section from only one side (i.e., the second end-side) of the ceramic sheet.

In the above ceramic heater, on the ceramic sheet, all of the second straight segments and curved segments together occupy an area which has a length in the longitudinal direction of the ceramic sheet greater than the distance between the center lines of the first straight segments in the lateral direction of the ceramic sheet.

With the above configuration, it is possible to make the longitudinal direction of the heater pattern coincident with the longitudinal direction of the ceramic sheet. In other words, it is possible to adapt the shape of the heater pattern to that of the ceramic sheet.

In the ceramic heater, the distance between the center lines of the first straight segments in the lateral direction of the ceramic sheet is in a range of 1.5 to 3.5 mm.

Specifying the range of the distance as above, it is possible to secure both the reliability and compactness of the ceramic heater.

In the ceramic heater, a minimum distance between any separated pair of the first straight segments, second straight segments, and curved segments is in a range of 0.2 to 1 mm.

Specifying the range of the minimum distance as above, it is possible to secure both the reliability and compactness of the ceramic heater.

According to a second aspect of the present invention, there is provided a gas sensor element that includes a solid electrolytic body, a pair of electrodes, and a ceramic heater.

The solid electrolytic body is conductive of oxygen ion and has an opposite pair of first and second surfaces. The electrodes are respectively provided on the first and second surfaces of the solid electrolytic body. The ceramic heater includes an insulative ceramic sheet and a heater pattern. The ceramic sheet is provided on one of the first and second surfaces of the solid electrolytic body and has first and second ends that are opposite to each other in a longitudinal direction of the ceramic sheet. The heater pattern is formed on the ceramic sheet and includes a heating section for generating heat. The heating section has a meandering shape to include a pair of first straight segments, a plurality of second straight segments, and a plurality of curved segments. Each of the first straight segments extends in the longitudinal direction of the ceramic sheet and has a center line. The second straight segments are interposed between the first straight segments in a lateral direction of the ceramic sheet which is perpendicular to the longitudinal direction of the ceramic sheet. Each of the second straight segments extends obliquely with respect to the longitudinal direction of the ceramic sheet. Each of the curved segments connects an adjacent pair of the first and second straight segments and has a center line. Further, the sum of curvature diameters of the center lines of the curved segments is greater than a distance between the center lines of the first straight segments in the lateral direction of the ceramic sheet.

With the above configuration, it is possible to downsize the gas sensor element without sacrificing the reliability of the ceramic heater. Consequently, the thermal capacity of the gas sensor element can be decreased, thereby improving the prompt activation capability of the gas sensor element. Moreover, when the temperature of the gas sensor element is rapidly increased by the ceramic heater for prompt activation, it is still possible to reliably prevent occurrence of cracks in the heater pattern of the ceramic heater due to excessive heat stress. As a result, both the prompt activation capability and compactness of the gas sensor element can be secured.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a plan view of a ceramic heater according to an embodiment of the present invention;

FIG. 2 is a longitudinal cross-sectional view of a gas sensor element which includes the ceramic heater of FIG. 1;

FIG. 3 is a lateral cross-sectional view of the gas sensor element;

FIG. 4 is a plan view of a prior art ceramic heater; and

FIG. 5 is a graphical representation giving a comparison between the ceramic heaters of FIGS. 1 and 4.

### DESCRIPTION OF PREFERRED EMBODIMENT

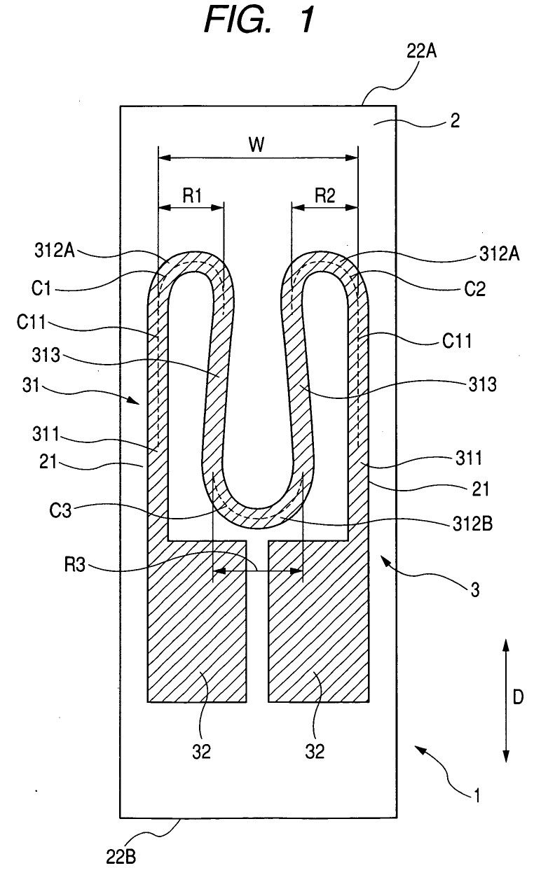

One preferred embodiment of the present invention will be described hereinafter with reference to FIGS. 1-5.

FIG. 1 shows the overall configuration of a ceramic heater 1 according to an embodiment of the invention. As shown, the ceramic heater 1 includes an insulative ceramic sheet 2 and a heater pattern 3.

The ceramic sheet 2 is made of, for example, alumina. The ceramic sheet 2 has first and second ends 22A and 22B that are opposite to each other in the longitudinal direction D of the ceramic sheet 2.

The heater pattern 3 is formed by printing a conductive metal paste (e.g., Pt paste) on the ceramic sheet 2 and firing it with the ceramic sheet 2 in an environment of a high temperature, for example, up to 1600° C. The heater pattern 3 includes a heating section 31 for generating heat and a pair of lead sections 32 for supplying electric power to the heating section 31.

The heating section 31 has a meandering shape to shuttle several times in the longitudinal direction D of the ceramic sheet 2. More specifically, in the present embodiment, the heating section 31 includes a pair of first straight segments 311, a pair of second straight segments 313, a pair of first curved segments 312A, and a second curved segment 312B. The first straight segments 311 are respectively arranged on an opposite pair of laterally outer portions 21 of the ceramic sheet 2 to extend in the longitudinal direction D. The second straight segments 313 are interposed between the first straight segments 311 in the lateral direction of the ceramic sheet 2 (i.e., the direction perpendicular to the longitudinal direction D) and extend obliquely with respect to the longitudinal direction D. Each of the first curved segments 312A connects, on the side of the first end 22A of the ceramic sheet 2, ends of an adjacent pair of one of the first straight segments 311 and one of the second straight segments 313. The first curved segments 312A have center lines C1 and C2, respectively; the center lines C1 and C2 have curvature diameters R1 and R2, respectively. On the other hand, the second curved segment 312B connects, on the side of the second end 22B of the ceramic sheet 2, the pair of the second straight segments 313. The curved segment 312B has a center line C3, which has a curvature diameter C3. It should be noted that the curvature diameters R1-R3 here denote quantities twice the curvature radiuses of the center lines C1-C3 of the first and second curved segments 312A and 312B, respectively. Further, in the present embodiment, (R1+R2+R3)>W, where W is the distance between center lines C1 of the first straight segments 311 in the lateral direction of the ceramic sheet 2 and represents the overall width of the heater pattern 3.

The lead sections 32 are arranged on the ceramic sheet 2 in alignment with each other in the lateral direction of the ceramic sheet 2 and closer to the second end 22B of the ceramic sheet 2 than the heating section 31. The lead sections 32 are respectively connected to the first straight segments 311 of the heating section 31.

It should be noted that the lengths of the heating section 31 and lead sections 32 of the heater pattern 3 are only schematically shown in FIG. 1 for the purpose of illustration; in practice, those lengths can be suitably set in consideration of the length of the ceramic sheet 2 (or the overall length of the ceramic heater 1).

As a whole, the heater pattern 3 extends in the longitudinal direction D of the ceramic sheet 2, so that on the ceramic sheet 2, all of the second straight segments 313, first curved segments 312A, and second curved segment 312B together occupy an area which has a length in the longitudinal direction D greater than the overall width W of the heater pattern 3. Further, in the present embodiment, the overall width W of the heater pattern 3 is in the range of 1.5 to 3.5 mm; the minimum distance between any separated pair of the first straight segments 311, second straight segments 313, first curved segments 312A, and second curved segment 312B is in the range of 0.2 to 1 mm.

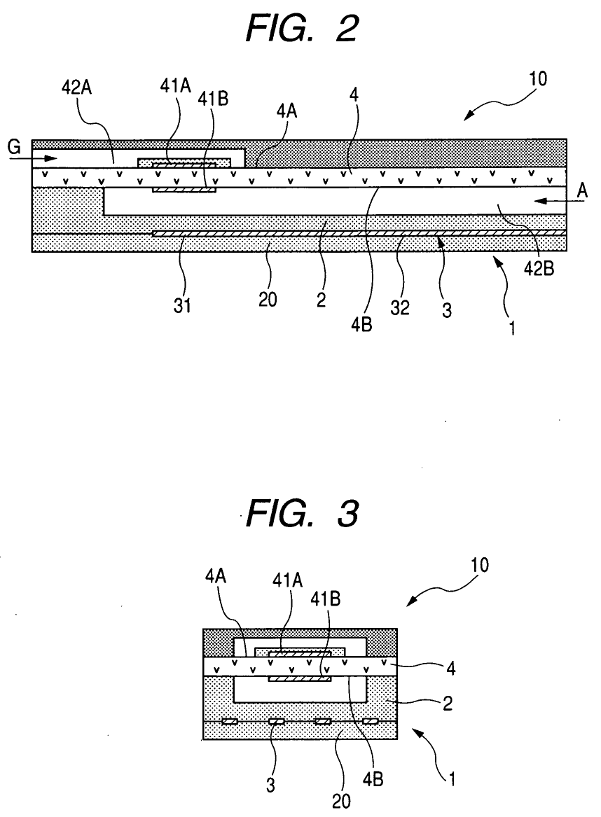

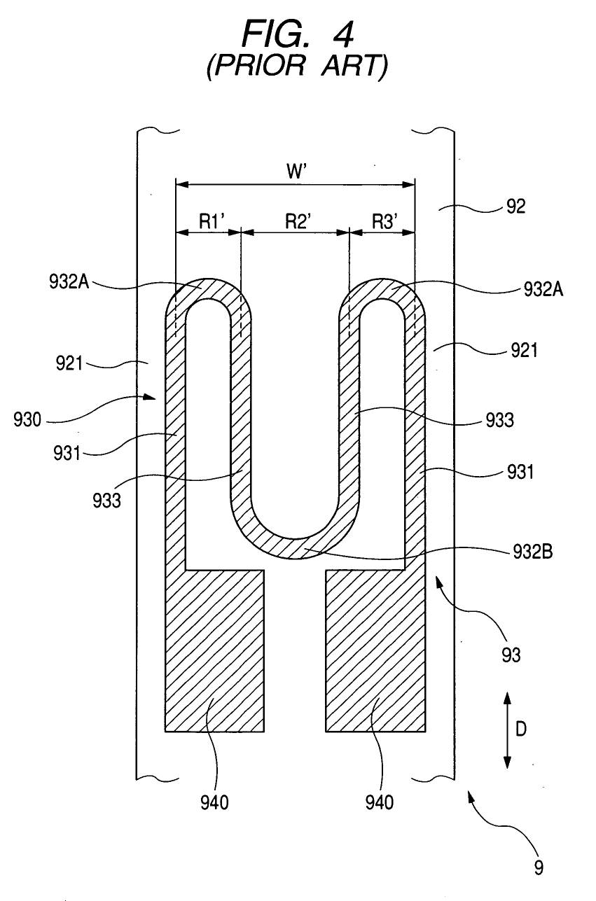

Referring now to FIGS. 2 and 3, a gas sensor element 10 according to the present embodiment, which includes the ceramic heater 1, will be described hereinafter.

The gas sensor element 10 can be used in an internal combustion engine to detect, for example, the difference in oxygen concentration between a gas G to be measured (e.g., the emission gas of the engine) and a reference gas A (e.g., air). The gas sensor element 10 includes, in addition to the ceramic heater 1, a solid electrolytic body 4, a pair of electrodes 41A and 41B, and an insulative ceramic sheet 20.

The solid electrolytic body 4 is conductive of oxygen ion and has an opposite pair of surfaces 4A and 4B. The solid electrolytic body 4 is made of, for example, a ceramic material including zirconia.

The electrodes 41A and 41B are respectively provided on the surfaces 4A and 4B of the solid electrolytic body 4 to align with each other in a direction perpendicular to the surfaces 4A and 4B. The electrodes 41A and 41B are formed by, for example, printing a conductive metal paste (e.g., Pt) on the surfaces 4A and 4B.

The ceramic heater 1 is provided on the second surface 4B of the solid electrolytic body 4. On the ceramic heater 1, there is further stacked the ceramic sheet 20 to cover the ceramic heater 1.

Moreover, in the gas sensor element 10, there are formed two hollow spaces 42A and 42B, into which the gas G to be measured and the reference gas A are respectively introduced. The electrodes 41A and 41B are located in the hollow spaces 42A and 42B to function as a measured gas-side electrode and a reference gas-side electrode, respectively.

After having described the overall configurations of the ceramic heater 1 and gas sensor element 10, the advantages thereof will be described hereinafter.

In the ceramic heater 1, as described above, the heating section 31 has a meandering shape to include the first straight segments 311, the second straight segments 313, and the first and second curved segments 312A and 312B. The first straight segments 311 extend in the longitudinal direction D of the ceramic sheet 2, whereas the second straight segments 313 extend obliquely with respect to the longitudinal direction D. The first and second curved segments 312A and 312B are curved over 180° to connect corresponding ends of the first and second straight segments 311 and 313. Further, by making the second straight segments 313 oblique with respect to the longitudinal direction D, the sum of the curvature diameters R1, R2, and R3 of the first and second curved segments 312A and 312B are made greater than the overall width W of the heater pattern 3.

With the above configuration, it is possible to secure large curvature diameters R1, R2, and R3 of the first and second curved segments 312A and 312B while reducing the overall width W of the heater pattern 3.

Consequently, with the large curvature diameters R1, R2, and R3, it is possible to ensure that the heater pattern 3 is printed on the ceramic sheet 2 with high quality. Further, with the high quality of printing, the distribution of electric resistance in the heater pattern 3 can be made regular, thereby preventing the occurrence of a break or cracks due to excessive heat stress in the heater pattern 3. Moreover, with the reduced overall width W, the ceramic heater 1 can be downsized. As a result, both the reliability and compactness of the ceramic heater 1 can be secured.

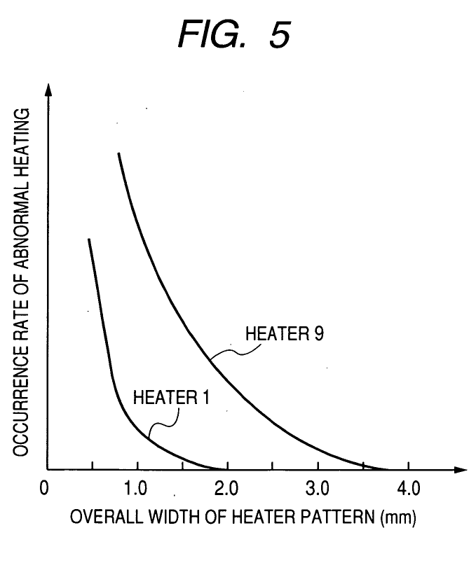

FIG. 5 gives a comparison between the ceramic heater 1 according to the present embodiment and the conventional ceramic heater 9 which has been previously described with reference to FIG. 4. In FIG. 5, the horizontal axis represents the overall width of heater pattern, while the vertical one represents the occurrence rate of abnormal heating.

As can be seen from FIG. 5, the ceramic heater 1 has a much lower occurrence rate of abnormal heating than the ceramic heater 9 over all the overall width. In other words, the ceramic heater 1 can be more easily downsized, without sacrificing reliability, than the ceramic heater 9.

In the ceramic heater 1, all of the second straight segments 313, first curved segments 312A, and second curved segment 312B together occupy an area which has a length in the longitudinal direction D of the ceramic sheet 2 greater than the overall width W of the heater pattern 3.

With the above configuration, it is possible to make the longitudinal direction of the heater pattern 3 coincident with the longitudinal direction D of the ceramic sheet 2. In other words, it is possible to adapt the shape of the heater pattern 3 to that of the ceramic sheet 2.

In the ceramic heater 1, the overall width W of the heater pattern 3 is in the range of 1.5 to 3.5 mm.

Specifying the range of the overall width W as above, it is possible to secure both the reliability and compactness of the ceramic heater 1. If the overall width W is less than 1.5 mm, it is difficult to prevent occurrence of abnormal heating in the ceramic heater 1. On the contrary, if the overall width W is greater than 3.5 mm, it is difficult to make the ceramic heater 1 compact.

In the ceramic heater 1, the minimum distance between any separated pair of the first straight segments 311, second straight segments 313, first curved segments 312A, and second curved segment 312B is in the range of 0.2 to 1 mm.

Specifying the range of the minimum distance as above, it is possible to secure both the reliability and compactness of the ceramic heater 1. If the minimum distance is less than 0.2 mm, it is difficult to secure the quality of printing the heater pattern 3 on the ceramic sheet 2 and thus difficult to prevent occurrence of abnormal heating in the ceramic heater 1. On the contrary, if the minimum distance is greater than 1 mm, it is difficult to make the ceramic heater 1 compact.

The gas sensor element 10 according to the present embodiment includes the above-described ceramic heater 1.

Accordingly, it is possible to downsize the gas sensor element 10 without sacrificing the reliability of the ceramic heater 1. Consequently, the thermal capacity of the gas sensor element 10 can be decreased, thereby improving the prompt activation capability of the gas sensor element 10. Moreover, when the temperature of the gas sensor element 10 is rapidly increased by the ceramic heater 1 for prompt activation, it is still possible to reliably prevent occurrence of cracks in the heater pattern 3 of the ceramic heater 1 heater due to excessive heat stress. As a result, both the prompt activation capability and compactness of the gas sensor element 10 can be secured.

While the above particular embodiment of the invention has been shown and described, it will be understood by those skilled in the art that various modifications, changes, and improvements may be made without departing from the spirit of the invention.

For example, in the previous embodiment, the heating section 31 of the heater pattern 3 includes only two second straight segments 313, two first curved segments 312A, and one second curved segment 312B.

However, it is also possible for the heating section 31 to include more than two second straight segments 313, more than two first curved segments 312A, and more than one second curved segment 312B.

What is claimed is:

1. A ceramic heater comprising:
an insulative ceramic sheet having first and second ends that are opposite to each other in a longitudinal direction of the ceramic sheet; and
a heater pattern formed on the ceramic sheet and including a heating section for generating heat, the heating section having a meandering shape to include a pair of first straight segments, a plurality of second straight segments, and a plurality of curved segments, each of the first straight segments extending in the longitudinal direction of the ceramic sheet and having a center line, the second straight segments being interposed between the first straight segments in a lateral direction of the ceramic sheet which is perpendicular to the longitudinal direction of the ceramic sheet, each of the second straight segments extending obliquely with respect to the longitudinal direction of the ceramic sheet, each of the curved segments connecting an adjacent pair of the first and second straight segments and having a center line,
wherein the sum of curvature diameters of the center lines of the curved segments is greater than a distance between the centerlines of the first straight segments in the lateral direction of the ceramic sheet.

2. The ceramic heater as set forth in claim 1, wherein the heater pattern further includes a pair of lead sections for supplying electric power to the heating section, the lead sections being arranged on the ceramic sheet in alignment with each other in the lateral direction of the ceramic sheet and closer to the second end of the ceramic sheet than the heating section in the longitudinal direction of the ceramic sheet,
each of the first straight segments includes first and second ends that are opposite to each other in the longitudinal direction of the ceramic sheet, the second end of each of the first straight segments being connected to a corresponding one of the lead sections,
the plurality of second straight segments are only two second straight segments, each of which includes a first end and a second end that is closer to the lead sections than the first end of the second straight segment, and
the plurality of curved segments consist of a pair of first curved segments and a second curved segment, each of the first curved segments connecting the first ends of an adjacent pair of one of the first straight segments and one of the second straight segments, the second curved segment connecting the second ends of the pair of the second curved segments.

3. The ceramic heater as set forth in claim 1, wherein on the ceramic sheet, all of the second straight segments and the curved segments together occupy an area which has a length in the longitudinal direction of the ceramic sheet greater than the distance between the centerlines of the first straight segments in the lateral direction of the ceramic sheet.

4. The ceramic heater as set forth in claim 1, wherein the distance between the centerlines of the first straight segments in the lateral direction of the ceramic sheet is in a range of 1.5 to 3.5 mm.

5. The ceramic heater as set forth in claim 1, wherein a minimum distance between any separated pair of the first straight segments, second straight segments, and curved segments is in a range of 0.2 to 1 mm.

6. A gas sensor element comprising:
a solid electrolytic body being conductive of oxygen ion and having an opposite pair of first and second surfaces;
a pair of electrodes respectively provided on the first and second surfaces of the solid electrolytic body; and
a ceramic heater including an insulative ceramic sheet and a heater pattern,
the ceramic sheet being provided on one of the first and second surfaces of the solid electrolytic body and having first and second ends that are opposite to each other in a longitudinal direction of the ceramic sheet,
the heater pattern being formed on the ceramic sheet and including a heating section for generating heat, the heating section having a meandering shape to include a pair of first straight segments, a plurality of second straight segments, and a plurality of curved segments, each of the first straight segments extending in the longitudinal direction of the ceramic sheet and having a center line, the second straight segments being interposed between the first straight segments in a lateral direction of the ceramic sheet which is perpendicular to the longitudinal direction of the ceramic sheet, each of the second straight segments extending obliquely with respect to the longitudinal direction of the ceramic sheet, each of the curved segments connecting an adjacent pair of the first and second straight segments and having a center line,
wherein the sum of curvature diameters of the center lines of the curved segments is greater than a distance between the centerlines of the first straight segments in the lateral direction of the ceramic sheet.

7. The gas sensor element as set forth in claim 6, wherein the heater pattern further includes a pair of lead sections for supplying electric power to the heating section, the lead sections being arranged on the ceramic sheet in alignment with each other in the lateral direction of the ceramic sheet and closer to the second end of the ceramic sheet than the heating section in the longitudinal direction of the ceramic sheet,
each of the first straight segments includes first and second ends that are opposite to each other in the longitudinal direction of the ceramic sheet, the second end of each of the first straight segments being connected to a corresponding one of the lead sections,
the plurality of second straight segments are only two second straight segments, each of which includes a first end and a second end that is closer to the lead sections than the first end of the second straight segment, and
the plurality of curved segments consist of a pair of first curved segments and a second curved segment, each of the first curved segments connecting the first ends of an adjacent pair of one of the first straight segments and one of the second straight segments, the second curved segment connecting the second ends of the pair of the second curved segments.

8. The gas sensor element as set forth in claim 6, wherein on the ceramic sheet, all of the second straight segments and the curved segments together occupy an area which has a length in the longitudinal direction of the ceramic sheet greater than the distance between the centerlines of the first straight segments in the lateral direction of the ceramic sheet.

9. The gas sensor element as set forth in claim 6, wherein the distance between the centerlines of the first straight segments in the lateral direction of the ceramic sheet is in a range of 1.5 to 3.5 mm.

10. The gas sensor element as set forth in claim 6, wherein a minimum distance between any separated pair of the first straight segments, second straight segments, and curved segments is in a range of 0.2 to 1 mm.
